(19) United States
(12) Patent Application Publication
(10) Pub. No.: US 2014/0028726 A1
(43) Pub. Date: Jan. 30, 2014

(54) WIRELESS DATA TRANSFER BASED SPANNING, EXTENDING AND/OR CLONING OF DISPLAY DATA ACROSS A PLURALITY OF COMPUTING DEVICES

(71) Applicants: Dhaval Dave, Ahmedabad (IN); Neel Patel, Junagadh (IN); Sourabh Kunden, Pune (IN)

(72) Inventors: Dhaval Dave, Ahmedabad (IN); Neel Patel, Junagadh (IN); Sourabh Kunden, Pune (IN)

(73) Assignee: NVIDIA Corporation, Santa Clara, CA (US)

(21) Appl. No.: 13/561,744

(22) Filed: Jul. 30, 2012

(51) Int. Cl. G09G 5/00

(52) U.S. Cl. 345/660; 345/2.3

(57) ABSTRACT

A method includes pairing a computing device with one or more another computing device(s) through a first wireless communication channel, and enabling data transfer between the computing device and the one or more another computing device(s) through a second wireless communication channel following the pairing. The method also includes providing a capability to span, extend and/or clone display data of the computing device rendered on a display unit thereof across a display unit of the one or more another computing device(s) in accordance with the enabled data transfer.

### FIELD OF TECHNOLOGY

This disclosure relates generally to display units and, more particularly, to a method, an apparatus and/or a system of wireless data transfer based spanning, extending and/or cloning of display data across a plurality of computing devices.

### BACKGROUND

A display unit of a computing device may be limited by a size capability thereof to display data (e.g., image, video) to a user. Data displayed on the computing device may be required to be viewed by a number of individuals at a same location. The individuals may possess computing device(s) therewith. One way of enabling the individuals to view the data is to e-mail files(s) associated with the data thereto. Another way of enabling the individuals to view the data is to transfer the aforementioned file(s) through a portable memory device. The aforementioned processes may be cumbersome and/or inefficient.

Processes such as using a magnifying lens to enlarge the display may be expensive and also cumbersome. Utilizing multiple ports of a Graphics Processing Unit (GPU; the GPU may include a number of processors coupled to one another) may enable division of the display area into portions corresponding to the number of GPU ports. The aforementioned division may enable spanning of the display data across the multiple GPU ports. However, the capability of the aforementioned process may, again, be limited by the number of GPU ports and properties of the GPU.

### SUMMARY

Disclosed are a method, an apparatus and/or a system of wireless data transfer based spanning, extending and/or cloning of display data across a plurality of computing devices.

In one aspect, a method includes pairing a computing device with one or more another computing device(s) through a first wireless communication channel, and enabling data transfer between the computing device and the one or more another computing device(s) through a second wireless communication channel following the pairing. The method also includes providing a capability to span, extend and/or clone display data of the computing device rendered on a display unit thereof across a display unit of the one or more another computing device(s) in accordance with the enabled data transfer.

In another aspect, a system includes a computing device including a display unit, and one or more another computing device(s) including another display unit. The computing device is configured to pair the one or more another computing device(s) therewith through a first wireless communication channel and enable data transfer between the computing device and the one or more another computing device(s) through a second wireless communication channel following the pairing. The computing device is also configured to provide a capability to span, extend and/or clone display data of the computing device rendered on the display unit thereof across the another display unit of the one or more another computing device(s) in accordance with the enabled data transfer.

In yet another aspect, a non-transitory machine-readable medium including instructions embodied therein that are executable through a computing device and one or more another computing device(s) is disclosed. The non-transitory machine-readable medium includes instructions to pair the computing device with the one or more another computing device(s) through a first wireless communication channel, and instructions to enable data transfer between the computing device and the one or more another computing device(s) through a second wireless communication channel following the pairing. The non-transitory machine-readable medium also includes instructions to provide a capability to span, extend and/or clone display data of the computing device rendered on a display unit thereof across a display unit of the one or more another computing device(s) in accordance with the enabled data transfer.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a display spanning, extending and cloning system, according to one or more embodiments.

FIG. 2 is a schematic view of a user interface of a “server” computing device of the display spanning, extending and cloning system of FIG. 1, according to one or more embodiments.

FIG. 3 is a schematic view of spanning of display data across a “server” computing device and a “client” computing device, according to one or more embodiments.

FIG. 4 is a schematic view of spanning of display data across three computing devices, according to one or more embodiments.

FIG. 5 is a schematic view of spanning of display data across four computing device.

FIG. 6 is a schematic view of an example “server” computing device and a “client” computing device executing a corresponding “server” operating system and a “client” operating system thereon respectively.

FIG. 7 is a schematic view of a dataflow between the “server” computing device and the “client” computing device of FIG. 6 during a spanning operation, according to one or more embodiments.

FIG. 8 is a schematic view of a dataflow between the “server” computing device and the “client” computing device of FIG. 6 during a cloning operation, according to one or more embodiments.

FIG. 9 is a schematic view of an example cloned screen of the “server” computing device at the “client” computing device of FIG. 6.

FIG. 10 is a process flow diagram detailing the operations involved in wireless data transfer based spanning, extending and/or cloning of display data across a number of computing devices, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of wireless data transfer based spanning, extending and/or cloning of display data across a plurality of computing devices. Although the present embodiments have been described with reference to specific example embodiments, it will be evident that various modifications and changes may be made to these embodiments without departing from the broader spirit and scope of the various embodiments.

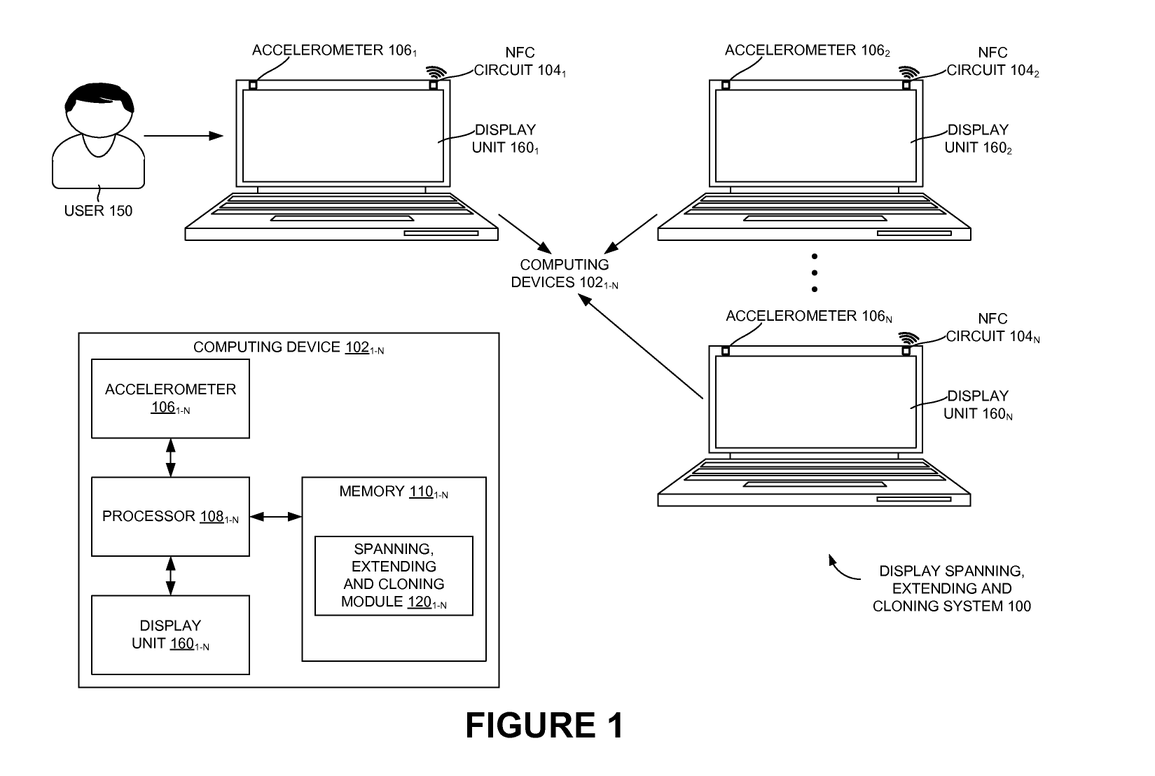

FIG. 1 shows a display spanning, extending and cloning system 100, according to one or more embodiments. In one or more embodiments, display spanning, extending and cloning system 100 may include a number of computing devices 102_{1-N} (e.g., a laptop, a personal computer (PC), a tablet, a mobile device such as a mobile phone, a smart television, any data processing device with a display unit and a wireless data transfer capability), each of which is Near-Field Communication (NFC) enabled. For the aforementioned purpose, in one or more embodiments, each computing device 102₁-N may include an NFC circuit 104_{1-N}. In one or more embodiments, NFC circuit 104_{1-N} may have transmission and reception capabilities and may be utilized to pair computing devices 102_{1-N} (to be discussed below).

In one or more embodiments, each computing device 102_{1-N} may also include an accelerometer 106_{1-N} for user interface control therein. The capabilities and concepts involved in the functioning of accelerometers and NFC circuits are well known to one of ordinary skill in the art and, therefore, detailed discussion associated therewith has been skipped for the sake of brevity and convenience. In one or more embodiments, exemplary embodiments offer a capability to span, extend and/or clone display screens of a computing device 102_{1-N} across at least one other computing device 102_{1-N}.

In one or more embodiments, each computing device 102_{1-N} may have a set of instructions associated with the display screen spanning, extending and/or cloning capabilities installed thereon. In one or more embodiments, for the aforementioned purpose, a non-transitory machine-readable medium including but not limited to one of a Compact Disc (CD), a Digital Video Disc (DVD) and a Blu-ray Disc™ may include appropriate instructions embodied therein that can be executable through each computing device 102_{1-N}. Alternately, the set of instructions may be downloaded from, for example, the Internet and installed on each computing device 102_{1-N}. In one example embodiment, there may be a separate set of instructions available for a computing device 102_{1-N} to serve as a “server” to other one or more “client” computing devices 102_{1-N}. In another example embodiment, the same set of instructions may enable one computing device 102_{1-N} to serve as the “server” and the other one or more computing devices 102_{1-N} to act as “clients.”

FIG. 1 shows each computing device 102_{1-N} as having a processor 108_{1-N} communicatively coupled to a memory 110_{1-N} (e.g., a volatile memory). In one or more embodiments, processor 108_{1-N} may be configured to address storage locations of memory 110_{1-N}. In one or more embodiments, each computing device 102_{1-N} may also include a display unit 160_{1-N} configured to have data rendered thereon to be spanned/extended across display units 160_{1-N} of the other one or more “client” computing devices 102_{1-N}. Alternately, in one or more embodiments, the data rendered on display unit 160_{1-N} may be cloned across the other one or more “client” computing devices 102_{1-N}.

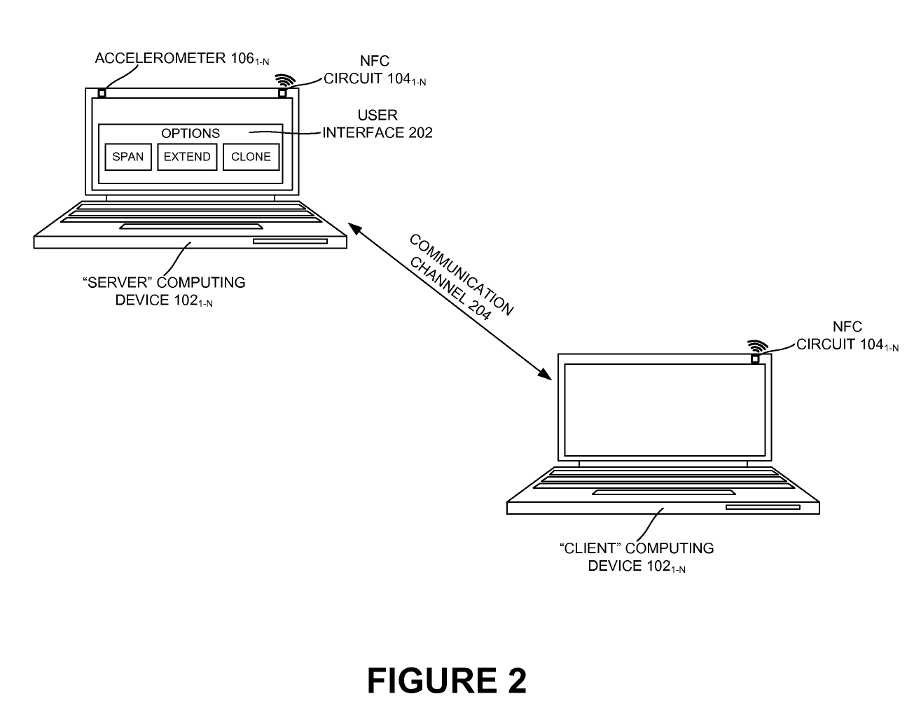

FIG. 1 shows processor 108_{1-N} being communicatively coupled to display unit 160_{1-N} and accelerometer 106_{1-N}. FIG. 1 also shows instructions associated with a spanning, extending and cloning module 120_{1-N} being stored in memory 110_{1-N}, the instructions being configured to be executed by processor 108_{1-N}. In one or more embodiments, when spanning, extending and cloning module 120_{1-N} is executed on processor 108_{1-N} of a “server” computing device 102_{1-N}, an option may be provided to a user 150 thereof through a user interface 202 (see FIG. 2) to span, extend or clone the display screen of the “server” computing device 102_{1-N} across the other one or more “client” computing devices 102_{1-N}.

FIG. 2 shows user interface 202 of “server” computing device 102_{1-N}, according to one or more embodiments. Once user 150 chooses the spanning, extending or cloning option, NFC circuit 104_{1-N} thereon may detect the other one or more “client” computing devices 102_{1-N}. In one or more embodiments, thus, the other one or more “client” computing devices 102_{1-N} may be paired with “server” computing device 102_{1-N}. It is obvious that any computing device 102_{1-N} may serve as the “server” and any other computing device 102_{1-N} may serve as a “client.” In one or more embodiments, following the pairing, the “server” computing device 102_{1-N} may enable a communication channel (e.g., a communication channel 204 based on Wi-Fi™) with the other one or more “client” computing devices 102_{1-N}. In one or more embodiments, “server” computing device 102_{1-N} may then enable data rendered on display unit 160_{1-N} thereof to be spanned, extended or cloned across the other one or more “client” computing devices 102_{1-N}.

In one or more embodiments, in order for proper spanning/extending of data across the other one or more “client” computing devices 102_{1-N}, the other one or more “client” computing devices 102_{1-N} may be physically bumped with “server” computing device 102_{1-N}. In one or more embodiments, the bumping may enable accelerometer 106_{1-N} of “server” computing device 102_{1-N} detect movement from a direction of the other one or more “client” computing devices 102_{1-N}. In one or more embodiments, in accordance therewith, “server” computing device 102_{1-N} may enable data rendered thereon to be spanned/extended across the other one or more “client” computing devices 102_{1-N}.

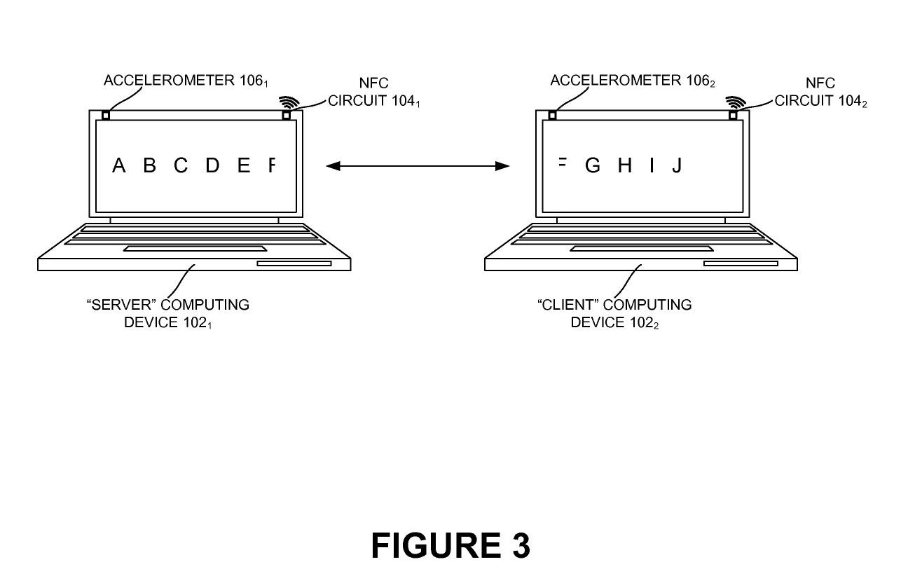

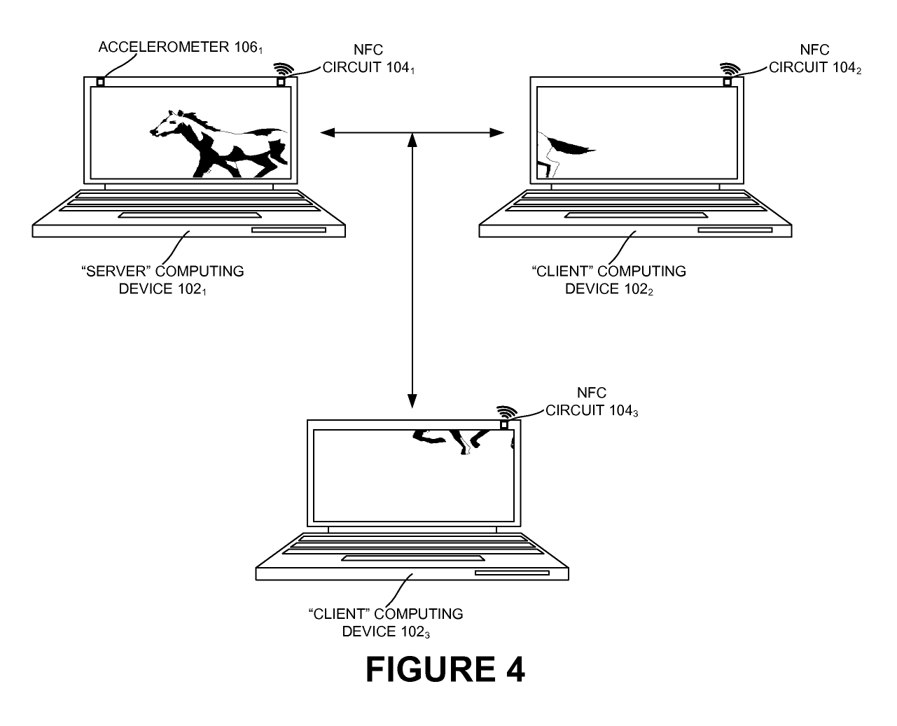

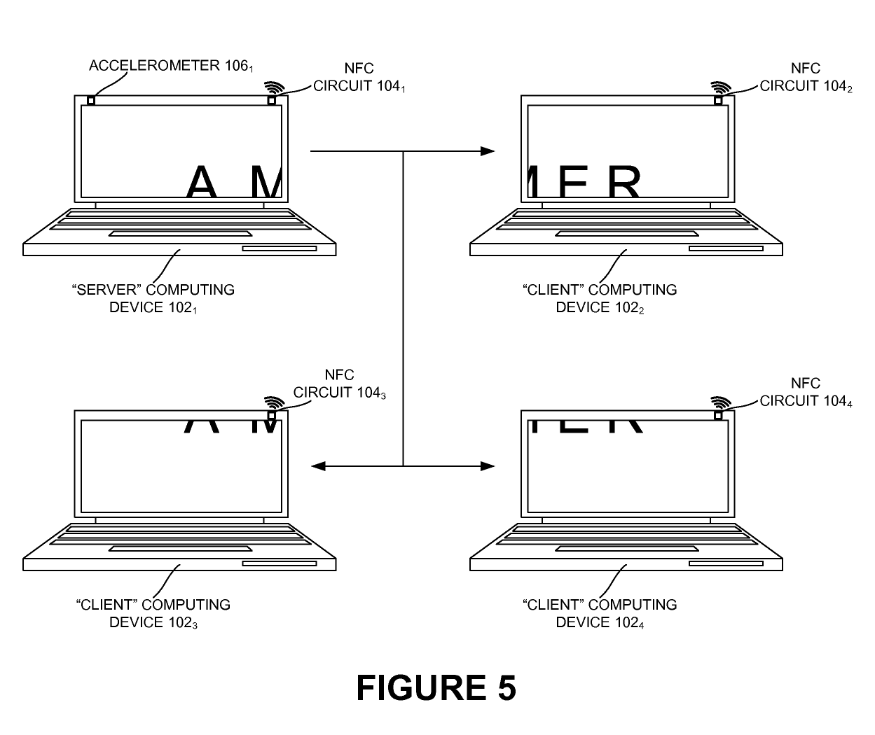

FIG. 3 illustrates the spanning of data across a “server” computing device 102₁ and a “client” computing device 102₂. As mentioned above, accelerometer 160₁ of “server” computing device 102₁ may detect movement from a direction of “client” computing device 102₂ based on the bump therebetween, in accordance with which “server” computing device 102₁ may span display data across the “client” computing device 102₂. FIG. 4 illustrates spanning of display data across three computing devices 102₁₋₃, and FIG. 5 illustrates spanning of the display data across four computing devices 102₁₋₄. The bumping of the computing devices 102₂₋₃ or 102₂₋₄ with “server” computing device 102₁ for the purpose of spanning may then be easily understood.

In one or more embodiments, the maximum number of display units 160_{1-N} to have data spanned thereacross may only be limited by the communication channel between the “server” computing device 102_{1-N} and the other one or more “client” computing devices 102_{1-N}. It is obvious to envision an M×M (say 2×2 as in FIG. 5; L×M, with L being different from M, is also possible) grid having display data spanned thereacross for user 150 to capture a “big screen” appearance without compromising on resolution.

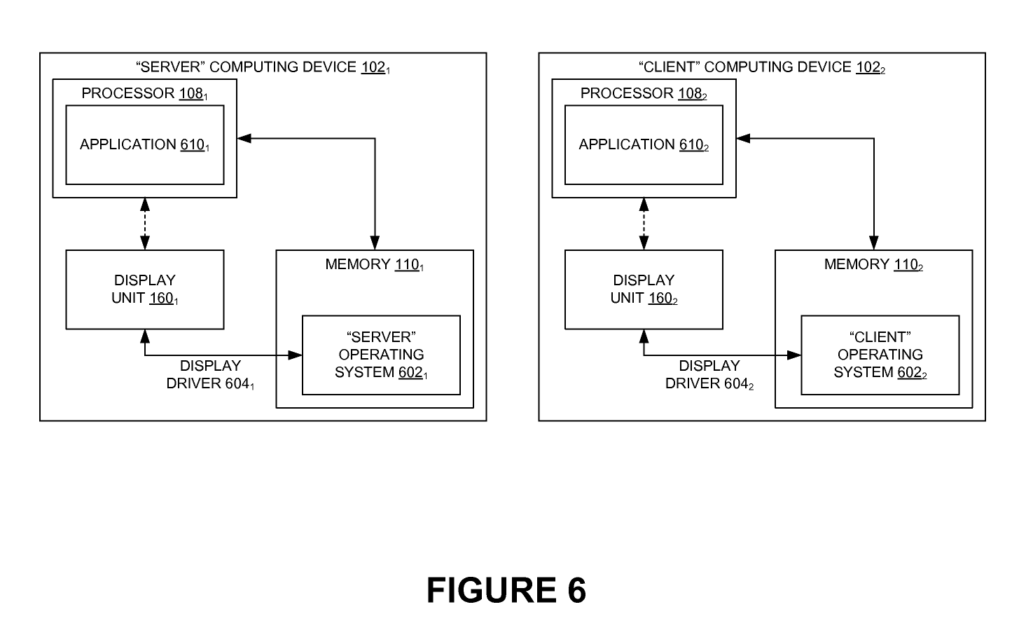

FIG. 6 shows an example “server” computing device 102₁ and a “client” computing device 102₂ executing a corresponding “server” operating system 602₁ and a “client” operating system 602₂ (shown as part of memory 110₁ and memory 110₂ respectively) thereon respectively. In one or more embodiments, an application 610₁/610₂ corresponding to the spanning (and cloning, as will be discussed later) operation may execute on each of “server” computing device 102₁ and “client” computing device 102₂. In one or more embodiments, “server” computing device 102₁ and “client” computing device 102₂ each may also include a display driver 604₁/604₂ (e.g., a software driver) to facilitate communication between display unit 160₁/160₂ and operating system 602₁/602₂ (and/or application 610₁/610₂).

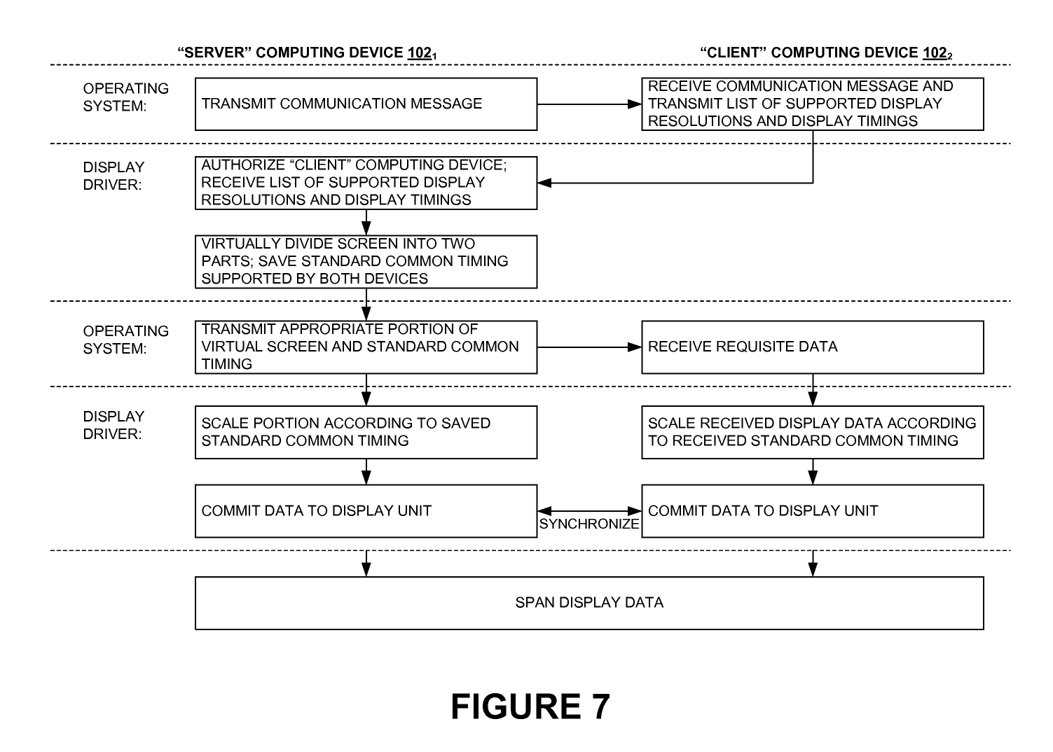

FIG. 7 shows a dataflow between “server” computing device 102₁ and “client” computing device 102₂ in accordance with a spanning operation. In one or more embodiments, as discussed above, each of “server” computing device 102₁ and “client” computing device 102₂ may execute an appropriate set of instructions (e.g., through application 610₁/610₂) to facilitate the spanning process. In one or more embodiments, NFC circuit 104₁ of “server” computing device 102₁ may detect “client” computing device 102₂, following which “client” computing device 102₂ may be bumped with “server” computing device 102₁ to initiate the spanning process.

In one or more embodiments, at first, “server” computing device 102₁ may initiate a communication process with “client” computing device 102₂ at the operating system level by transmitting an appropriate message. In one or more embodiments, “client” computing device 102₂ may acknowledge receipt of the message and operating system 602₂ thereof may transmit supported display resolutions and display timings to “server” computing device 102₁. In one or more embodiments, “server” computing device 102₁ may then authorize “client” computing device 102₂ and receive the display resolutions and display timings supported by “client” computing device 102₂.

In one or more embodiments, display driver 604₁ of “server” computing device 102₁ may include instructions to virtually divide a screen of display unit 160₁ thereof into two parts (it is obvious that three “client” pairings may divide the screen into four parts) and save a standard display timing supported on both “server” computing device 102₁ and “client” computing device 102₂ based on the received display timings from “client” computing device 102₂. In one or more embodiments, “server” computing device 102₁ may then transmit display data associated with the portion to be scanned across “client” computing device 102₂ along with the standard display timing supported by both devices to “client” computing device 102₂ at the operating system level. In one or more embodiments, “client” computing device 102₂ may also receive the aforementioned data at the operating system level.

In one or more embodiments, display driver 604₁ of “server” computing device 102₁ may include instructions to scale data associated with the portion to be displayed thereon in accordance with the saved standard display timing supported by both devices, and to commit the virtual scaled screen data to the corresponding display unit 160₁. In one or more embodiments, display driver 604₂ of “client” computing device 102₂ may include instructions to scale the received portion of display data from “server” computing device 102₁ in accordance with the received standard display timing supported by both devices, and to commit the virtual scaled screen data to the corresponding display unit 160₂. In one or more embodiments, display driver 604₁ of “server” computing device 102₁ may also include instructions to synchronize the virtual scaled screen data of the two computing devices 102₁/102₂ for optimal user experience.

The abovementioned processes may complete the spanning of display data across display units 160₁ and 160₂. It is obvious to see that the cloning of screen data across multiple computing devices 102_{1-N} may also involve one or more of the abovementioned processes discussed with regard to the spanning. In one or more embodiments, “server” computing device 102_{1-N} and the other one or more “client” computing devices 102_{1-N} may be paired through NFC circuit 104_{1-N} of “server” computing device 102_{1-N}. In one or more embodiments, the other one or more “client” computing devices 102_{1-N} may then be merely bumped with “server” computing device 102₁-N to enable the cloning process. It is obvious that direction detection may not be required during the cloning process.

Also, it is obvious that spanning (and/or cloning discussed below) may not require standard common display timing(s) between “server” computing device 102_{1-N} and the other one or more “client” computing devices 102_{1-N}, as discussed with regard to FIG. 7. Different display timing(s) and resolutions between individual display unit(s) 160₁-N (e.g., in a scenario of spanning displays between a mobile phone and a tablet) are within the scope of the exemplary embodiments.

Further, it is obvious that extending may also involve one or more processes similar to that of spanning. However, extending may involve providing each of “server” computing device 102_{1-N} and the other one or more “client” computing devices 102_{1-N} with an own frame buffer thereof. In this case, each display unit 160_{1-N} may have different depth, resolution, display timings and/or refresh rate. It is to be understood that additional “desktop” area is created during extending in contrast to virtually dividing a screen in the case of spanning. The display data corresponding to the additional “desktop” area related to the “client” computing devices 102_{1-N} may be transmitted thereto from “server” computing device 102_{1-N}. “Server” computing device 102_{1-N} and “client” computing devices 102_{1-N} may have display data thereof appropriately scaled to fit display units 160_{1-N} thereof.

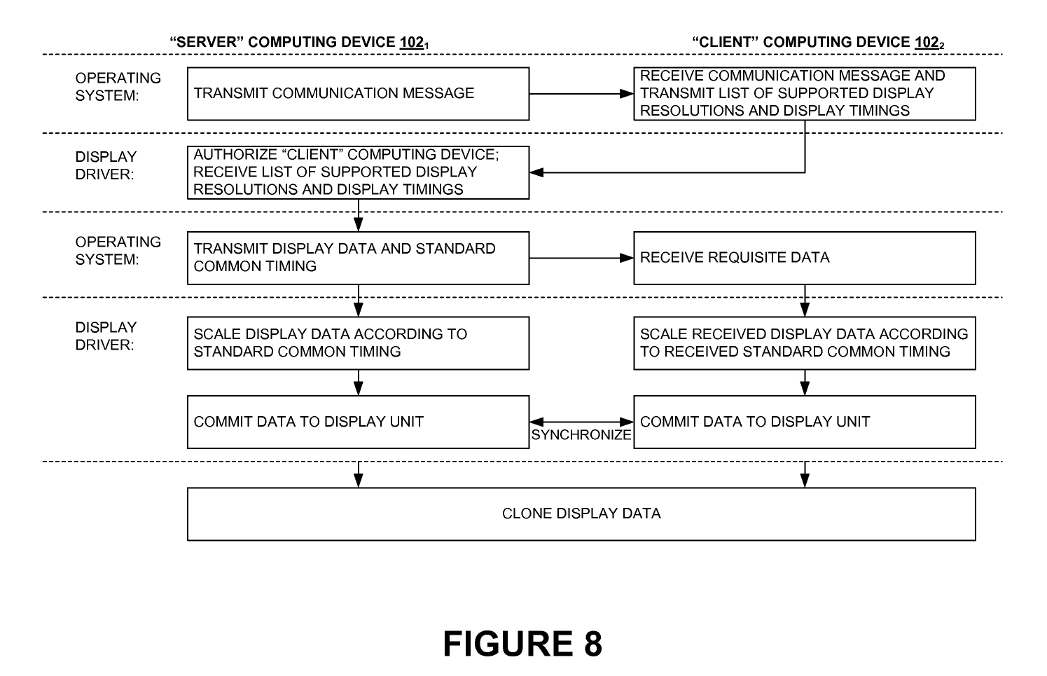

FIG. 8 shows a dataflow between “server” computing device 102₁ and “client” computing device 102₂ in accordance with a cloning operation. In one or more embodiments, as discussed above, each of “server” computing device 102₁ and “client” computing device 102₂ may execute an appropriate set of instructions (e.g., through application 610₁/610₂) to facilitate the cloning process. In one or more embodiments, NFC circuit 104₁ of “server” computing device 102₁ may detect “client” computing device 102₂, following which “client” computing device 102₂ may be bumped with “server” computing device 102₁ to initiate the cloning process.

In one or more embodiments, at first, “server” computing device 102₁ may initiate a communication process with “client” computing device 102₂ at the operating system level by transmitting an appropriate message. In one or more embodiments, “client” computing device 102₂ may acknowledge receipt of the message and operating system 602₂ thereof may transmit supported display resolutions and display timings to “server” computing device 102₁. In one or more embodiments, “server” computing device 102₁ may then authorize “client” computing device 102₂ and receive the display resolutions and display timings supported by “client” computing device 102₂.

In one or more embodiments, display driver 604₁ of “server” computing device 102₁ may include instructions to save a standard display timing supported on both “server” computing device 102₁ and “client” computing device 102₂ based on the received display timings from “client” computing device 102₂. In one or more embodiments, “server” computing device 102₁ may then transmit display data associated with the screen thereof to “client” computing device 102₂ along with the standard display timing supported by both devices at the operating system level. In one or more embodiments, “client” computing device 102₂ may also receive the aforementioned data at the operating system level.

In one or more embodiments, display driver 604₁ of “server” computing device 102₁ may include instructions to scale data (if required) to be displayed thereon in accordance with the saved standard display timing supported by both devices, and to commit the virtual scaled screen data to the corresponding display unit 160₁. In one or more embodiments, display driver 604₂ of “client” computing device 102₂ may include instructions to scale the received display data from “server” computing device 102₁ in accordance with the received standard display timing supported by both devices, and to commit the virtual scaled screen data to the corresponding display unit 160₂. In one or more embodiments, display driver 604₁ of “server” computing device 102₁ may also include instructions to synchronize the virtual scaled screen data of the two computing devices 102₁/102₂ for optimal user experience.

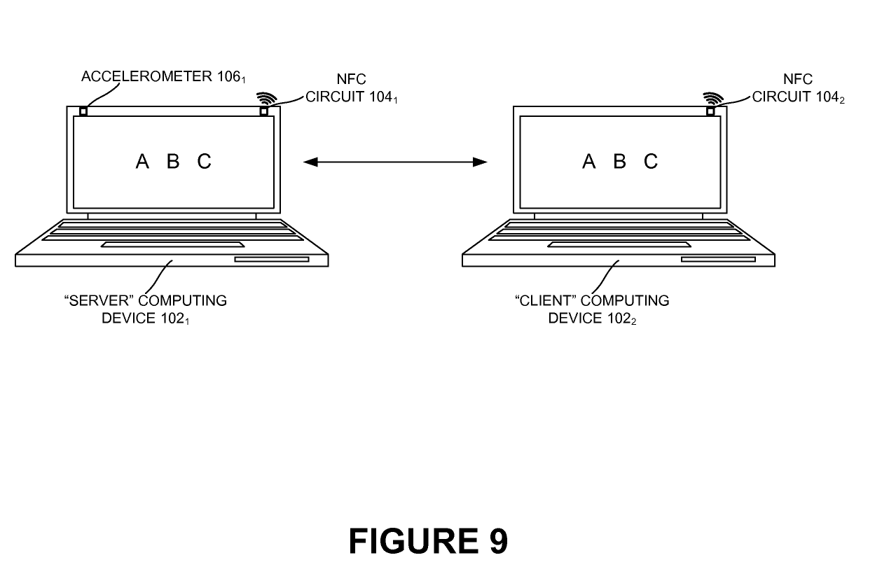

The abovementioned processes may complete the cloning operation. FIG. 9 shows an example cloned screen of a “server” computing device 102₁ at a “client” computing device 102₂. While it is obvious that display data may be cloned across a number of “client” computing devices 102_{1-N}, the maximum number of supported “client” computing devices 102_{1-N} may, again, only be limited by the communication channel between the “server” computing device 102_{1-N} and “client” computing devices 102₁-N. The aforementioned cloning of screen data may make it possible for a number of users to view similar screen content.

A use case scenario may be envisioned for the cloning operation. In one or more embodiments, user 150 may busy with a presentation to a target audience on a topic of interest. User 150 may have slides associated with the presentation open on “server” computing device 102₁ thereof. Whenever an attendee joins in, he/she may merely be required to physically touch (or, bump) his/her “client” computing device 102₂ with “server” computing device 102₁ in order for the display screen of “server” computing device 102₁ to be cloned across “client” computing device 102₂. This may dispense with a requirement for user 150 to e-mail the presentation slides to the attendee(s).

While exemplary embodiments discussed herein have been discussed in the figures with reference to NFC and an example wireless communication channel based on Wi-Fi™, any form of wireless communication (e.g., Bluetooth®) utilized for pairing of computing devices 102_{1-N} and/or data transfer therebetween is within the scope of the exemplary embodiments. It may even be possible for a single wireless communication channel to be adequate for the pairing and the data transfer. It may also be possible to use the Internet instead of wirelessly communicating directly between computing devices 102_{1-N} to span, extend and/or clone display data thereacross. Dissimilar operating systems (operating system 602₁ and operating system 602₂) of computing devices 102₁/102₂ may also be supported during the cloning and/or the spanning processes.

As discussed above, a non-transitory machine-readable medium including but not limited to one of a CD, a DVD and a Blu-ray Disc™ may include appropriate instructions for the spanning, extending and/or cloning embodied therein that can be executable through each computing device 102_{1-N}. Alternately, the instructions for the spanning, extending and/or cloning may be downloaded to each computing device 102_{1-N}. In another example embodiment, the aforementioned instructions may be packaged with the display driver (e.g., display driver 604₁) of the appropriate computing device (e.g., computing device 102₁).

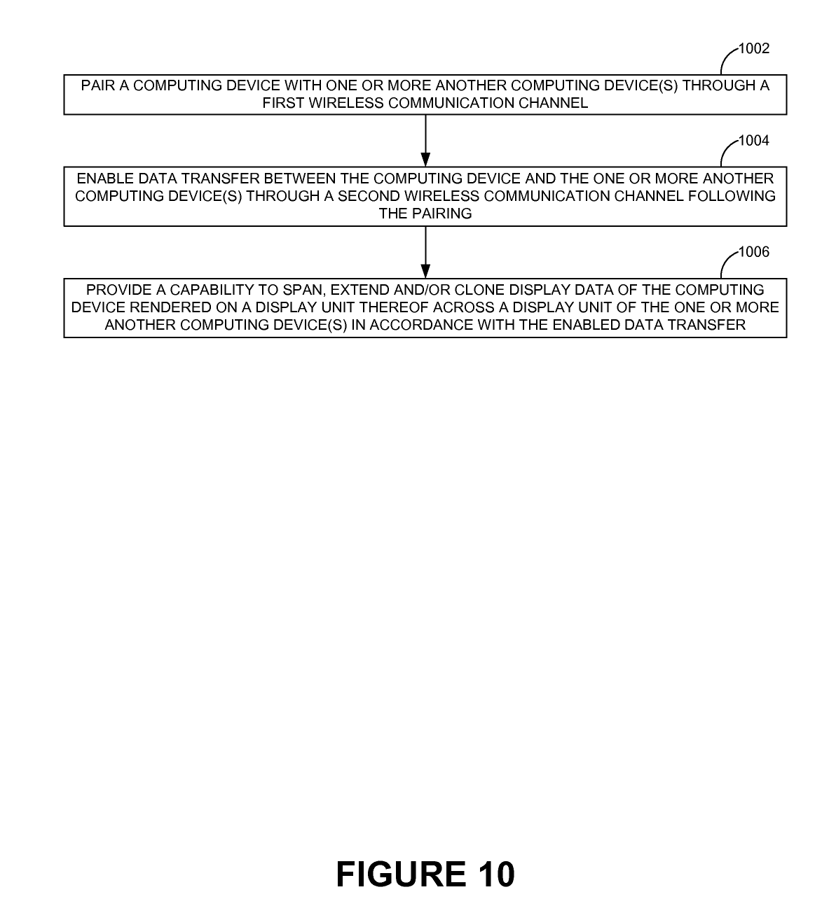

FIG. 10 shows a process flow diagram detailing the operations involved in wireless data transfer based spanning, extending and/or cloning of display data across a number of computing devices 102_{1-N}, according to one or more embodiments. In one or more embodiments, operation 1002 may involve pairing a computing device 102₁ with one or more another computing device(s) 102₂ through a first wireless communication channel (e.g., NFC based). In one or more embodiments, operation 1004 may involve enabling data transfer between computing device 102₁ and the one or more another computing device(s) 102₂ through a second wireless communication channel (e.g., Wi-Fi™) following the pairing. In one or more embodiments, operation 1006 may then involve providing a capability to span, extend and/or clone display data of computing device 102₁ rendered on a display unit 160₁ thereof across a display unit 160₂ of the one or more another computing device(s) 102₂ in accordance with the enabled data transfer.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method comprising:
pairing a computing device with at least one another computing device through a first wireless communication channel;
enabling data transfer between the computing device and the at least one another computing device through a second wireless communication channel following the pairing; and
providing a capability to at least one of: span, extend and clone display data of the computing device rendered on a display unit thereof across a display unit of the at least one another computing device in accordance with the enabled data transfer.

2. The method of claim 1, wherein providing the capability to at least one of: span, extend and clone the display data of the computing device further comprises:
providing a capability to detect movement from a direction of the at least one another computing device through an accelerometer of the computing device in accordance with a physical bumping of the at least one another computing device with the computing device to enable the at least one of: spanning, extending and cloning of the display data of the computing device rendered on the display unit thereof across the display unit of the at least one another computing device.

3. The method of claim 1, wherein at least one of:
the first wireless communication channel is one of: the same as the second wireless communication channel and different from the second wireless communication channel, and
the first wireless communication channel is Near Field Communication (NFC) based and the second wireless communication channel is Wi-Fi™ based.

4. The method of claim 1, wherein spanning the display data further comprises:
transmitting a communication message from the computing device to the at least one another computing device;
receiving, at the computing device, an acknowledgement message back from the at least one another computing device, along with a list of display resolutions and display timings supported by the at least one another computing device;
authorizing, through a display driver of the display unit of the computing device, the at least one another computing device in accordance with the acknowledgement message;
virtually dividing a display screen into appropriate portions in accordance with a common display timing supported on both the computing device and the at least one another computing device, the common display timing being identified based on the received list of display resolutions and display timings supported by the at least one another computing device;
transmitting display data associated with a portion of the display screen to be rendered on the display unit of the at least one another computing device and the common display timing from the computing device to the at least one another computing device;
scaling the appropriate portion of the display screen to be rendered on the display unit of the computing device in accordance with the common display timing; and
scaling the appropriate portion of the display screen to be rendered on the display unit of the at least one another computing device in accordance with the common display timing and the received display data.

5. The method of claim 1, wherein cloning the display data further comprises:
transmitting a communication message from the computing device to the at least one another computing device;
receiving, at the computing device, an acknowledgement message back from the at least one another computing device, along with a list of display resolutions and display timings supported by the at least one another computing device;
authorizing, through a display driver of the display unit of the computing device, the at least one another computing device in accordance with the acknowledgement message;
identifying a common display timing based on the received list of display resolutions and display timings supported by the at least one another computing device;
transmitting display data to be rendered on the display unit of the at least one another computing device and the common display timing from the computing device to the at least one another computing device;
scaling the display data to be rendered on the display unit of the computing device based on the common display timing; and
scaling the received display data to be rendered on the display unit of the at least one another computing device based on the common display timing.

6. The method of claim 1, wherein extending the display data further comprises:
transmitting, from the computing device, display data to be rendered on the display unit of the at least one another computing device to the at least one another computing device;
scaling display data to be rendered on the display unit of the computing device based on an appropriate display timing suited thereto; and
scaling the display data to be rendered on the display unit of the at least one another computing device based on another appropriate display timing suited thereto.

7. The method of claim 4, further comprising:
synchronizing the scaled display data of the computing device and the at least one another computing device.

8. The method of claim 5, further comprising:
synchronizing the scaled display data of the computing device and the at least one another computing device.

9. A system comprising:
a computing device comprising a display unit; and
at least one another computing device comprising another display unit, the computing device being configured to:
pair the at least one another computing device therewith through a first wireless communication channel,
enable data transfer between the computing device and the at least one another computing device through a second wireless communication channel following the pairing, and
provide a capability to at least one of: span, extend and clone display data of the computing device rendered on the display unit thereof across the another display unit of the at least one another computing device in accordance with the enabled data transfer.

10. The system of claim 9, wherein the computing device further comprises an accelerometer to provide a capability to detect movement from a direction of the at least one another computing device in accordance with a physical bumping of the at least one another computing device with the computing device to enable the at least one of: spanning, extending and cloning of the display data of the computing device rendered on the display unit thereof across the another display unit of the at least one another computing device.

11. The system of claim 9, wherein at least one of:
the first wireless communication channel is one of: the same as the second wireless communication channel and different from the second wireless communication channel, and
the first wireless communication channel is NFC based and the second wireless communication channel is Wi-Fi™ based.

12. The system of claim 9, wherein, in accordance with the spanning of display data,
the computing device is configured to transmit a communication message to the at least one another computing device,
the computing device is configured to receive an acknowledgement message back from the at least one another computing device, along with a list of display resolutions and display timings supported by the at least one another computing device,
the computing device is configured to authorize, through a display driver of the display unit, the at least one another computing device in accordance with the acknowledgement message,
the computing device is configured to virtually divide a display screen into appropriate portions in accordance with a common display timing supported on both the computing device and the at least one another computing device, the common display timing being identified based on the received list of display resolutions and display timings supported by the at least one another computing device,
the computing device is configured to transmit display data associated with a portion of the display screen to be rendered on the another display unit of the at least one another computing device and the common display timing to the at least one another computing device,
the computing device is configured to scale the appropriate portion of the display screen to be rendered on the display unit in accordance with the common display timing, and
the at least one another computing device is configured to scale the appropriate portion of the display screen to be rendered on the another display unit in accordance with the common display timing and the received display data.

13. The system of claim 9, wherein, in accordance with the cloning of display data,
the computing device is configured to transmit a communication message to the at least one another computing device,
the computing device is configured to receive an acknowledgement message back from the at least one another computing device, along with a list of display resolutions and display timings supported by the at least one another computing device,
the computing device is configured to authorize, through a display driver of the display unit, the at least one another computing device in accordance with the acknowledgement message,
the computing device is configured to identify a common display timing based on the received list of display resolutions and display timings supported by the at least one another computing device,
the computing device is configured to transmit display data to be rendered on the another display unit of the at least one another computing device and the common display timing to the at least one another computing device,
the computing device is configured to scale the display data to be rendered on the display unit based on the common display timing, and
the at least one another computing device is configured to scale the received display data to be rendered on the another display unit based on the common display timing.

14. The system of claim 9, wherein, in accordance with extending the display data,
the computing device is configured to transmit display data to be rendered on the display unit of the at least one another computing device to the at least one another computing device,
the computing device is configured to scale display data to be rendered on the display unit thereof based on an appropriate display timing suited thereto, and
the at least one another computing device is configured to scale the display data to be rendered on the display unit thereof based on another appropriate display timing suited thereto.

15. The system of claim 12, wherein the computing device is further configured to enable synchronization of the scaled display data between the computing device and the at least one another computing device.

16. The system of claim 13, wherein the computing device is further configured to enable synchronization of the scaled display data between the computing device and the at least one another computing device.

17. The system of claim 9, wherein the computing device and the at least one another computing device are at least one of: a laptop, a personal computer (PC), a tablet, a mobile device and a smart television.

18. A non-transitory machine-readable medium comprising instructions embodied therein that are executable through a computing device and at least one another computing device, comprising:
instructions to pair the computing device with the at least one another computing device through a first wireless communication channel;
instructions to enable data transfer between the computing device and the at least one another computing device through a second wireless communication channel following the pairing; and
instructions to provide a capability to at least one of: span, extend and clone display data of the computing device rendered on a display unit thereof across a display unit of the at least one another computing device in accordance with the enabled data transfer.

19. The non-transitory machine-readable medium of claim 18, further comprising:
instructions to provide a capability to detect movement from a direction of the at least one another computing device through an accelerometer of the computing device in accordance with a physical bumping of the at least one another computing device with the computing device to enable the at least one of: spanning, extending and cloning of the display data of the computing device rendered on the display unit thereof across the display unit of the at least one another computing device.

20. The non-transitory machine-readable medium of claim 18, comprising instructions to enable the at least one of the spanning, the extending and the cloning of the display data to function in an environment where the first wireless communication channel is one of: the same as the second wireless communication channel and different from the second wireless communication channel.

21. The non-transitory machine-readable medium of claim 18, wherein, in accordance with the spanning of the display data, the non-transitory machine-readable medium further comprises instructions to:
transmit a communication message from the computing device to the at least one another computing device;
receive, at the computing device, an acknowledgement message back from the at least one another computing device, along with a list of display resolutions and display timings supported by the at least one another computing device;
authorize, through a display driver of the display unit of the computing device, the at least one another computing device in accordance with the acknowledgement message;
virtually divide a display screen into appropriate portions in accordance with a common display timing supported on both the computing device and the at least one another computing device, the common display timing being identified based on the received list of display resolutions and display timings supported by the at least one another computing device;
transmit display data associated with a portion of the display screen to be rendered on the display unit of the at least one another computing device and the common display timing from the computing device to the at least one another computing device;
scale the appropriate portion of the display screen to be rendered on the display unit of the computing device in accordance with the common display timing; and
scale the appropriate portion of the display screen to be rendered on the display unit of the at least one another computing device in accordance with the common display timing and the received display data.

22. The non-transitory machine-readable medium of claim 18, wherein, in accordance with the cloning of the display data, the non-transitory machine-readable medium further comprises instructions to:
transmit a communication message from the computing device to the at least one another computing device;
receive, at the computing device, an acknowledgement message back from the at least one another computing device, along with a list of display resolutions and display timings supported by the at least one another computing device;
authorize, through a display driver of the display unit of the computing device, the at least one another computing device in accordance with the acknowledgement message;
identify a common display timing based on the received list of display resolutions and display timings supported by the at least one another computing device;
transmit display data to be rendered on the display unit of the at least one another computing device and the common display timing from the computing device to the at least one another computing device;
scale the display data to be rendered on the display unit of the computing device based on the common display timing; and
scale the received display data to be rendered on the display unit of the at least one another computing device based on the common display timing.

23. The non-transitory machine-readable medium of claim 18, wherein, in accordance with extending the display data, then non-transitory machine-readable medium further comprises instructions to:
transmit, from the computing device, display data to be rendered on the display unit of the at least one another computing device to the at least one another computing device,
scale display data to be rendered on the display unit of the computing device based on an appropriate display timing suited thereto, and
scale the display data to be rendered on the display unit of the at least one another computing device based on another appropriate display timing suited thereto.
